(19) United States
(12) Patent Application Publication
(10) Pub. No.: US 2023/0246234 A1
(43) Pub. Date: Aug. 3, 2023

(54) LITHIUM SECONDARY BATTERY

(71) Applicant: SK ON CO., LTD., Seoul (KR)

(72) Inventor: You Jin SHIM, Daejeon (KR)

(21) Appl. No.: 18/104,788

(22) Filed: Feb. 2, 2023

(30) Foreign Application Priority Data
Feb. 3, 2022 (KR) 10-2022-0014277

(51) Int. Cl. H01M 10/0567; H01M 10/052; H01M 10/0585; H01M 10/0569; H01M 4/505; H01M 4/525

(52) U.S. Cl. CPC H01M 10/0567; H01M 10/052; H01M 10/0585; H01M 10/0569; H01M 4/505; H01M 4/525; H01M 2004/028

(57) ABSTRACT

A lithium secondary battery includes a cathode including a cathode active material that includes lithium metal oxide particles, an anode facing the cathode and including an anode active material, and an electrolyte solution including a lithium salt and an organic solvent. The lithium metal oxide particles contain at least 80 mol % of nickel and less than 10 mol % of manganese among all elements excluding lithium and oxygen. The organic solvent includes a mononitrile-based compound.

### CROSS-REFERENCE TO RELATED APPLICATION AND CLAIM OF PRIORITY

This application claims priority to Korean Patent Applications No. 10-2022-0014277 filed on Feb. 3, 2022 in the Korean Intellectual Property Office (KIPO), the entire disclosure of which is incorporated by reference herein.

### BACKGROUND

### 1. Field

The present invention relates to a lithium secondary battery. More particularly, the present invention relates to a lithium secondary battery including an electrode assembly and an electrolyte solution impregnating the electrode assembly.

### 2. Description of the Related Art

A secondary battery which can be charged and discharged repeatedly has been widely employed as a power source of an electric vehicle, a mobile electronic device such as a camcorder, a mobile phone, a laptop computer, etc.

A lithium secondary battery is highlighted and developed among various types of secondary batteries due to high operational voltage and energy density per unit weight, a high charging rate, a compact dimension, etc.

For example, the lithium secondary battery may include an electrode assembly including a cathode, an anode and a separation layer interposed between the cathode and the anode, and an electrolyte solution immersing the electrode assembly. The lithium secondary battery may further include an outer case for accommodating the electrode assembly and the electrolyte solution.

For example, the cathode may include a cathode current collector and a cathode active material layer including a cathode active material formed on the cathode current collector.

For example, the cathode active material may include lithium metal oxide particles capable of reversibly intercalating and de-intercalating lithium. For example, the lithium metal oxide particles may include a metal element such as nickel, cobalt, manganese, etc.

As an application of the lithium secondary battery is expanded, high capacity and life-span properties are required. For example, as the lithium secondary battery is applied to the electric vehicle, developments of the lithium secondary battery having improved rapid charging and life-span properties are required.

Korean Published Patent Application No. 10-2019-0119615 discloses a method of improving battery properties by adding an additive to an electrolyte solution for a lithium secondary battery.

### SUMMARY

According to an aspect of the present invention, there is provided a lithium secondary battery providing improved capacity and life-span.

A lithium secondary battery includes a cathode including a cathode active material that includes lithium metal oxide particles, an anode facing the cathode and including an anode active material, and an electrolyte solution including a lithium salt and an organic solvent. The lithium metal oxide particles contain at least 80 mol % of nickel and less than 10 mol % of manganese among all elements excluding lithium and oxygen, and the organic solvent includes a mononitrile-based compound represented by Chemical Formula 1.

R¹—C≡N [Chemical Formula 1]

In Chemical Formula 1, R¹ represents a C₁-C₁₂ alkyl group.

In some embodiments, the lithium metal oxide particles may contain 88 mol % to 98 mol % of nickel among all elements excluding lithium and oxygen.

In some embodiments, the lithium metal oxide particles may contain 0.5 mol % to 6 mol % of manganese among all elements excluding lithium and oxygen.

In some embodiments, a content of the mononitrile-based compound in the organic solvent may be in a range from 1 vol % to 9 vol %.

In some embodiments, in Chemical Formula 1, R¹ may be a C₂-C₄ linear alkyl group.

In some embodiments, the organic solvent may further include a cyclic carbonate-based solvent and a linear carbonate-based solvent.

In some embodiments, a content of the linear carbonate-based solvent may be greater than a content of the cyclic carbonate-based solvent in the organic solvent.

In some embodiments, a volume ratio of the cyclic carbonate-based solvent to the mononitrile-based compound in the organic solvent is in a range from 5 to 25.

In some embodiments, the linear carbonate-based solvent may include a first dialkyl carbonate-based solvent having a C₂-C₄ alkyl group at both terminal ends thereof, and a second dialkyl carbonate-based solvent in which at least one terminal group is a methyl group.

In some embodiments, the electrolyte solution may further include an additive including at least one of a fluorine-containing cyclic carbonate-based compound represented by Chemical Formula 2 and a sultone-based compound represented by Chemical Formula 3.

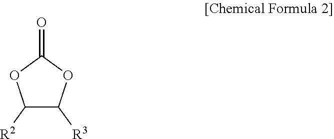

In Chemical Formula 2, R² and R³ are independently hydrogen, halogen, or a C₁-C₃ alkyl group, and at least one of R² and R³ is F.

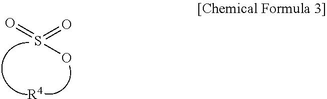

In Chemical Formula 3, R⁴ may be a C₂-C₅ alkylene group or a C₃-C₅ alkenylene group.

In some embodiments, a content of the additive may be in a range from 0.1 wt % to 5 wt % based on a total weight of the electrolyte solution.

In some embodiments, a content of the fluorine-containing cyclic carbonate-based compound may be in a range from 0.1 wt % to 2 wt % based on a total weight of the electrolyte solution, and a content of the sultone-based compound may be in a range from 0.1 wt % to 1 wt % based on the total weight of the electrolyte solution.

In some embodiments, the additive may further include at least one of a fluorine-containing phosphate-based compound, a sulfate-based compound and a borate-based compound.

In some embodiments, the electrolyte solution may not include a compound containing two or more nitrile groups.

A lithium secondary battery according to exemplary embodiments may include a cathode active material including lithium metal oxide particles containing nickel and manganese in predetermined contents, and an electrolyte solution containing a mononitrile-based compound represented by Chemical Formula 1. The lithium secondary battery may have a low initial resistance, improved capacity (e.g., a room temperature capacity and a low temperature capacity), and rapid charging life-span and high-temperature storage properties.

### BRIEF DESCRIPTION OF THE DRAWINGS

FIGS. 1 and 2 are a schematic plan view and a schematic cross-sectional view, respectively, illustrating a lithium secondary battery in accordance with exemplary embodiments.

### DETAILED DESCRIPTION OF THE EMBODIMENTS

The term “Ca-Cb” used herein may indicate that the number of carbon atoms is from a to b.

According to embodiments of the present invention, a lithium secondary battery including a cathode active material that includes lithium metal oxide particles containing nickel and manganese in predetermined contents, and an electrolyte solution including a mononitrile-based compound represented by Chemical Formula 1 to be described later is provided.

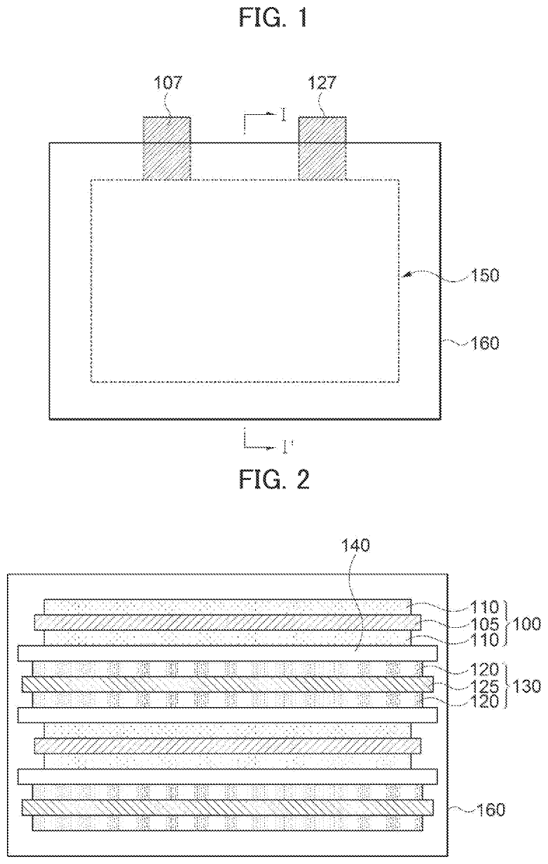

Hereinafter, a lithium secondary battery according to exemplary embodiments will be described in more detail with reference to accompanying drawings. Referring to FIGS. 1 and 2 are a schematic plan view and a cross-sectional view, respectively, of a lithium secondary battery according to exemplary embodiments. FIG. 2 is a cross-sectional view taken along a line I-I′ of FIG. 1.

Referring to FIGS. 1 and 2, a lithium secondary battery includes an electrode assembly 150 including a cathode 100 and an anode 130 facing the cathode 100, and an electrolyte solution (not illustrated) impregnating the electrode assembly 150.

For example, the lithium secondary battery may include a case 160 accommodating the electrode assembly 150 and the electrolyte solution.

In an embodiment, a separation layer 140 may be interposed between the anode 100 and the cathode 130. For example, the electrode assembly 150 may be formed by winding, stacking or z-folding of the separation layer 140.

The electrolyte solution may include a lithium salt and an organic solvent. For example, the organic solvent may have a sufficient solubility for the lithium salt.

The organic solvent may include a mononitrile-based compound represented by Chemical Formula 1 below.

R¹—C≡N [Chemical Formula 1]

In Chemical Formula 1, R¹ may be a C₁-C₁₂ alkyl group. In some embodiments, R¹ may be a C₁-C₆ alkyl group. For example, the alkyl group may be linear (a straight chain) or branched (a branched chain) (in the case of the branched chain, the number of carbon atoms is 3 or more).

In some embodiments, R¹ may be a C₂-C₄ linear alkyl group.

For example, the lithium secondary battery may include the mononitrile-based compound and lithium metal oxide particles containing predetermined amounts of nickel and manganese as will be described later. Accordingly, the lithium secondary battery may have improved capacity, rapid charge life-span, high-temperature storage life-span properties, etc.

In an embodiment, a content of the mononitrile-based compound may be in a range from 1 volume percent (vol %) to 9 vol %, preferably from 1 vol % to 5 vol %, based on a total volume of the organic solvent. Within this range, the high-temperature life-span properties of the lithium secondary battery may be further improved.

In an embodiment, the organic solvent may further include a carbonate-based solvent.

In some embodiments, the carbonate-based solvent may include a cyclic carbonate-based solvent and a linear carbonate-based solvent. For example, the cyclic carbonate-based solvent may have a 5 to 7-membered cyclic structure.

In some embodiments, an amount of the linear carbonate-based solvent in the organic solvent may be greater than that of the cyclic carbonate-based solvent.

In some embodiments, a volume ratio of the linear carbonate-based solvent relative to the cyclic carbonate-based solvent in the organic solvent may be greater than 1, and 9 or less, in a range from 2 to 7.5, or in a range from 2 to 3.5.

In some embodiments, a volume ratio of the cyclic carbonate-based solvent relative to the mononitrile-based compound in the organic solvent may be in a range from 5 to 25. Within this range, the high-temperature storage life-span properties of the lithium secondary battery may be further improved.

In some embodiments, the linear carbonate-based solvent may include a first dialkyl carbonate-based solvent having a C₂ to C₄ alkyl group at both terminal ends thereof, and a second dialkyl carbonate-based solvent in which at least one terminal group is a methyl group. In this case, the high-temperature storage life-span properties of the lithium secondary battery may be further improved.

In some embodiments, the organic solvent may further include an ester-based (carboxylate-based) solvent, an ether-based solvent, a ketone-based solvent, an alcohol-based solvent, etc.

For example, the ester solvent may include methyl acetate (MA), ethyl acetate (EA), n-propyl acetate (n-PA), 1,1-dimethylethyl acetate (DMEA), methyl propionate (MP), ethyl propionate (EP), etc.

For example, the ether solvent may include dibutyl ether, tetraethylene glycol dimethyl ether (TEGDME), diethylene glycol dimethyl ether (DEGDME), dimethoxyethane, tetrahydrofuran (THF), 2-methyltetrahydrofuran, etc.

For example, the ketone-based solvent may include cyclohexanone, etc.

For example, the alcohol-based solvent may include ethyl alcohol, isopropyl alcohol, etc.

The lithium salt may be represented by Li⁺X⁻. For example, the anion X⁻ may be any one selected from F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻.

In some embodiments, the lithium salt may include LiBF₄, LiPF₆, etc.

For example, the lithium salt may be included in a concentration from 0.01M to 5M, preferably from 0.01 M to 2M in the organic solvent. Within the above concentration range, mobility of lithium ions and/or electrons may be facilitated during charging and discharging of the lithium secondary battery.

In an embodiment, the electrolyte may further include an additive including at least one of a fluorine-containing carbonate-based compound and a sultone-based compound. In this case, the high-temperature storage life-span properties of the lithium secondary battery may be further improved while reducing an initial resistance of the lithium secondary battery.

In some embodiments, a content of the additive may be in a range from 0.1 wt % to 5 wt % based on a total weight of the electrolyte solution.

For example, the fluorine-containing carbonate-based compound may include a carbon atom to which a fluorine atom is directly boned or an alkyl group (e.g., —CF₃) to which a fluorine atom is bonded.

In an embodiment, the fluorine-containing carbonate-based compound may have a cyclic structure. For example, the fluorine-containing carbonate-based compound may have a 5 to 7-membered cyclic structure.

In an embodiment, the fluorine-containing carbonate-based compound may be represented by Chemical Formula 2 below.

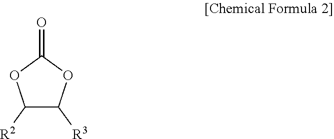

In Chemical Formula 2, R² and R³ may independently be hydrogen, halogen or a C₁-C₃ alkyl group (provided that at least one of R² and R³ is F).

In some embodiments, the fluorine-containing carbonate-based compound may include fluoroethylene carbonate (FEC).

In some embodiments, a content of the fluorine-containing cyclic carbonate-based compound may be in a range from 0.1 wt % to 2 wt %, from 0.1 wt % to 1.5 wt %, or 0.1 wt/o to 1 wt/o based on the total weight of the electrolyte.

For example, the sultone-based compound may have a 5 to 7-membered cyclic structure.

In an embodiment, the sultone-based compound may be represented by Chemical Formula 3 below.

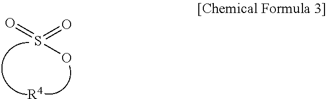

In Chemical Formula 3, R⁴ may be a C₂-C₅ alkylene group or a C₃-C₅ alkenylene group.

In some embodiments, R⁴ may be a C₂-C₅ alkylene group.

In some embodiments, a content of the sultone-based compound may be in a range from 0.1 wt % to 1.5 wt %, from 0.1 wt % to 1 wt %, or from 0.1 wt % to 0.5 wt % based on the total weight of the electrolyte.

In some embodiments, the sultone-based compound may include 1,3-propane sultone (PS), 1,4-butane sultone, ethensultone, 1,3-propene sultone (PRS), 1,4-butene sultone, 1-methyl-1,3-propene sultone, etc.

In some embodiments, the additive may further include a fluorine-containing phosphate-based compound, a sulfate-based compound, a borate-based compound, etc.

For example, a fluorine atom may be directly bonded to a phosphorus atom included in the fluorine-containing phosphate-based compound, or an alkyl group to which a fluorine atom is bonded may be included in the fluorine-containing phosphate-based compound.

In some embodiments, the fluorine-containing phosphate-based compound may include lithium difluorophosphate (LiPO₂F₂), lithium tetrafluorooxalate phosphate, lithium difluoro(bisoxalato)phosphate, etc.

For example, the sulfate-based compound may have a cyclic structure. For example, the sulfate-based compound may have a 5 to 7-membered cyclic structure.

In some embodiments, the sulfate-based compound may include ethylene sulfate (ESA), trimethylene sulfate (TMS), methyltrimethylene sulfate (MTMS), etc.

For example, the borate-based compound may include lithium tetraphenyl borate, lithium difluoro(oxalato) borate (LiODFB), etc.

In an embodiment, the electrolyte solution may not contain a compound containing two or more nitrile groups. For example, when the compound containing two or more nitrile groups is used together with lithium metal oxide particles to be described later, the initial resistance of the lithium secondary battery may be increased, and a low-temperature capacity and the rapid charge life-span properties may be deteriorated.

The cathode 100 may include a cathode current collector 105 and a cathode active material layer 110 formed on the cathode current collector 105.

For example, the cathode active material layer 110 may include a cathode active material, and may further include a cathode binder and a conductive material.

For example, a cathode slurry may be prepared by mixing and stirring the cathode active material, the cathode binder, the conductive material, a dispersive agent, etc. The cathode slurry may be coated on the cathode current collector 105, and then dried and pressed to form the cathode 100.

The cathode current collector 105 may include, e.g., stainless-steel, nickel, aluminum, titanium, copper or an alloy thereof.

For example, the cathode active material may include lithium metal oxide particles capable of reversibly intercalating and de-intercalating lithium ions.

In exemplary embodiments, the cathode active material may include the lithium metal oxide particles containing nickel. In some embodiments, the lithium metal oxide particles may further include at least one of cobalt and manganese.

For example, the lithium metal oxide particles may further include nickel and manganese.

In an embodiments, the lithium metal oxide particles may contain 80 mol % or more, 83 mol % or more, 85 mol % or more, 88 mol %, 90 mol % or more, or 95 mol % or more of nickel based on a total number of moles of all elements excluding lithium and oxygen. In the above range, a capacity of the lithium secondary battery may be more enhanced.

In some embodiments, the lithium metal oxide particles may include 88 mol % to 98 mol % of nickel based on the total number of moles of all elements excluding lithium and oxygen.

In some embodiments, the lithium metal oxide particles may contain 88 mol % to 98 mol % of nickel among all elements excluding lithium and oxygen.

In an embodiment, the lithium metal oxide particles may contain less than 10 mol %, preferably 8 mol % or less, more preferably 6 mol % or less of manganese based on the total number of moles of all elements excluding lithium and oxygen. In the above range, the low temperature capacity, the rapid charge life-span and high-temperature storage life-span properties of the lithium secondary battery may be further improved.

For example, if the content of manganese in the lithium metal oxide particle is 10 mol % or more, the low temperature capacity and the high-temperature storage life-span properties (e.g., a high temperature storage capacity retention) may be degraded when used with the mononitrile-based compound

In some embodiments, the lithium metal oxide particles may contain 0.5 mol % to 8 mol %, preferably 0.5 mol % to 6 mol % of manganese among all elements excluding lithium and oxygen.

In an embodiment, the lithium metal oxide particles may be represented by Chemical Formula 4.

LiₓNi_{(1-a-b)}MnₐM_{b}O_{y} [Chemical Formula 4]

In Chemical Formula 4, M may include at least one element selected from Co, Al, Zr, Ti, Cr, B, Mg, Ba, Si, Y, W and Sr, and 0.9≤x≤1.2, 1.9≤y≤2.1, 0<a+b≤0.2, and 0<a<0.1.

In some embodiments, 0<a+b≤0.17, 0<a+b≤0.15, 0<a+b≤0.12, 0<a+b≤0.1 or 0<a+b≤0.05.

In some embodiments, 0<a≤0.08 or 0<a≤0.06. In some embodiments, 0.005≤a≤0.08 or 0.005≤a≤0.06.

In an embodiment, the lithium metal oxide particles may further include a coating element or a doping element. For example, the coating element or doping element may include Al, Ti, Ba, Zr, Si, B, Mg, P, Sr, W, La, an alloy thereof, or an oxide thereof. In this case, the lithium secondary battery having more improved life-span properties may be implemented.

For example, the cathode binder may include an organic based binder such as polyvinylidenefluoride (PVDF), a polyvinylidene fluoride-hexafluoropropylene copolymer (PVDF-co-HFP), polyacrylonitrile, polymethylmethacrylate, etc., or an aqueous based binder such as styrene-butadiene rubber (SBR) that may be used with a thickener such as carboxymethyl cellulose (CMC).

The conductive material may include a carbon-based material such as graphite, carbon black, graphene, carbon nanotube, etc., and/or a metal-based material such as tin, tin oxide, titanium oxide, a perovskite material such as LaSrCoO₃ or LaSrMnO₃, etc.

The anode 130 may include an anode current collector 125 and an anode active material layer 120 on the anode current collector 125.

The anode active material layer 120 may include an anode active material, may further include an anode binder and a conductive material.

For example, the anode active material may be mixed and stirred together with the anode binder, the conductive material in a solvent to form an anode slurry. The anode slurry may be coated on the anode current collector 125, dried and pressed to obtain the anode 130.

For example, the anode current collector 125 may include gold, stainless-steel, nickel, aluminum, titanium, copper or an alloy thereof, preferably, may include copper or a copper alloy.

The anode active material may include a material which may be capable of adsorbing and ejecting lithium ions. For example, the anode active material may include a lithium alloy, a carbon-based material, a silicon-based material, etc.

For example, the lithium alloy may include a metal element such as aluminum, zinc, bismuth, cadmium, antimony, silicon, lead, tin, gallium, indium, etc.

For example, the carbon-based active material may include a crystalline carbon, an amorphous carbon, a carbon complex, a carbon fiber, etc.

The amorphous carbon may include, e.g., a hard carbon, cokes, a mesocarbon microbead (MCMB) fired at a temperature of 1500° C. or less, a mesophase pitch-based carbon fiber (MPCF), etc.

The crystalline carbon may include, e.g., artificial graphite, natural graphite, graphitized cokes, graphitized MCMB, graphitized MPCF, etc.

In an embodiment, the anode active material may include the silicon-based active material. The silicon-based active material may include, e.g., Si, SiOₓ(0<x<2), Si/C, SiO/C, Si-metal, etc. In this case, the lithium secondary battery having a high capacity may be implemented.

The anode binder and the conductive material substantially the same as or similar to the cathode binder and the conductive material as mentioned above may also be used in the anode. In some embodiments, the anode binder may include, e.g., an aqueous binder such as styrene-butadiene rubber (SBR). Further, the anode binder may be used together with a thickener such as carboxymethyl cellulose (CMC).

The separation layer 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like. The separation layer 140 may also include a non-woven fabric formed from a glass fiber with a high melting point, a polyethylene terephthalate fiber, or the like.

The lithium secondary battery according to exemplary embodiments may include a cathode lead 107 connected to the cathode 100 to protrude to an outside of a case 160, and an anode lead 127 connected to the anode 130 to protrude to the outside of the case 160.

For example, the cathode 100 and the cathode lead 107 may be electrically connected to each other. The anode 130 and the anode lead 127 may be electrically connected to each other.

For example, the cathode lead 107 may be electrically connected to the cathode current collector 105. The anode lead 130 may be electrically connected to the anode current collector 125.

For example, the cathode current collector 105 may include a protrusion (a cathode tab, not illustrated) at one side thereof. The cathode active material layer 110 may not be formed on the cathode tab. The cathode tab may be integral with the cathode current collector 105 or may be connected to the cathode current collector 105 by, e.g., welding. The cathode current collector 105 and the cathode lead 107 may be electrically connected via the cathode tab.

The anode current collector 125 may include a protrusion (an anode tab, not illustrated) at one side thereof. The anode active material layer 120 may not be formed on the anode tab. The anode tab may be integral with the anode current collector 125 or may be connected to the anode current collector 125 by, e.g., welding. The anode electrode current collector 125 and the anode lead 127 may be electrically connected via the anode tab.

In an embodiment, the electrode assembly 150 may include a plurality of the cathodes and a plurality of the anodes. For example, the cathode and the anode may be alternately arranged, and the separation layer may be interposed between the cathode and the anode. Accordingly, the lithium secondary battery according to an embodiment of the present invention may include a plurality of the cathode tabs and a plurality of the anode tabs protruding from the plurality of the cathodes and the plurality of the anodes, respectively.

In an embodiment, the cathode tabs (or the anode tabs) may be laminated, pressed and welded to form a cathode tab stack (or an anode tab stack). The cathode tab stack may be electrically connected to the cathode lead 107. The anode tab stack may be electrically connected to the anode lead 127.

The lithium secondary battery may be fabricated into a cylindrical shape using a can, a prismatic shape, a pouch shape, a coin shape, etc.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### Example 1

(1) Preparation of Electrolyte Solution

A 1M LiPF₆ solution was prepared using a mixed solvent having the composition shown in Table 1 below. Based on a total weight of the electrolyte, 1 wt % of fluoroethylene carbonate (FEC) and 0.5 wt % of 1,3-propane sultone (PS) were added to the LiPF₆ solution and mixed to prepare an electrolyte solution.

(2) Preparation of Lithium Secondary Battery Sample

Lithium metal oxide particles having the composition as shown in Table 1 below, carbon black and polyvinylidene fluoride (PVdF) were dispersed in NMP in a weight ratio of 98:1:1 to prepare a cathode slurry.

The cathode slurry was uniformly coated on an aluminum foil (thickness: 12 m), and then dried and pressed to form a cathode.

An anode slurry was prepared by mixing an anode active material having the composition as shown in Table 1 below, carbon black, styrene-butadiene rubber (SBR) and carboxymethyl cellulose (CMC) in a distilled water by a weight ratio of 96:3:1:1.

The anode slurry was uniformly coated on a copper foil (thickness: 8 μm), and then dried and pressed to form an anode.

The cathodes and the anode were alternately and repeatedly stacked with a polyethylene separator (thickness: 13 μm) interposed therebetween to form an electrode assembly.

The electrode assembly was accommodated in a pouch, and the electrolyte solution was injected and sealed to obtain a lithium secondary battery sample having a capacity level of 2 Ah.

### Examples 2 to 6, and Comparative Examples 1 to 4

Lithium secondary battery samples were prepared by the same method as that in Example 1, except that compositions of the mixed solvent in the electrolyte solution and the lithium metal oxide particles were changed as shown in Table 1 below.

TABLE 1

| | lithium metal | mixed solvent of |
|---|---|---|
| | oxide particle | electrolyte solution |
| Example 1 | LiNi_{0.88}Co_{0.06}Mn_{0.06}O₂ | EC + EMC + PN (25:70:5 v/v) |
| Example 2 | LiNi_{0.88}Co_{0.06}Mn_{0.06}O₂ | EC + EMC + BN (25:70:5 v/v) |
| Example 3 | LiNi_{0.88}Co_{0.06}Mn_{0.06}O₂ | EC + EMC + VN (25:70:5 v/v) |
| Example 4 | LiNi_{0.88}Co_{0.06}Mn_{0.06}O₂ | EC + EMC + DEC + BN |
| | | (25:50:20:5 v/v) |
| Example 5 | LiNi_{0.88}Co_{0.06}Mn_{0.06}O₂ | EC + EMC + IBN (25:70:5 v/v) |
| Example 6 | LiNi_{0.88}Co_{0.06}Mn_{0.06}O₂ | EC + EMC + BN (25:65:10 v/v) |
| Comparative | LiNi_{0.88}Co_{0.06}Mn_{0.06}O₂ | EC + EMC (25:75 v/v) |
| Example 1 | | |
| Comparative | LiNi_{0.88}Co_{0.06}Mn_{0.06}O₂ | EC + EMC + AN (25:70:5 v/v) |
| Example 2 | | |
| Comparative | NCM811 + NCM523 | EC + EMC (25:75 v/v) |
| Example 3 | (6:4 w/w) | |
| Comparative | NCM811 + NCM523 | EC + EMC + BN (25:70:5 v/v) |
| Example 4 | (6:4 w/w) | |

NCM811: LiNi_{0.8}Co_{0.1}Mn_{0.1}O₂
NCM523: LiNi_{0.5}Co_{0.2}Mn_{0.3}O₂
EC: Ethylene carbonate
EMC: Ethyl methyl carbonate
DEC: Diethyl carbonate
PN: Propionitrile
BN: Butyronitrile
IBN: Isobutyronitrile
VN: Valeronitrile
AN: Adiponitirile

### Experimental Example 1: Evaluation on Rapid Charging Life-Span Property

The lithium secondary batteries of Examples and Comparative Examples were charged by 0.33 C up to a state of charge (SOC) of 8%, charged by a stepwise manner of 2.5 C-2.25 C-2 C-1.75 C-1.5 C-1.0 C in an interval of SOC 8% to 80%, charged again by 0.33 C (4.2V, 0.05 C cut-oft) in the SOC 80-100% section, and then CC-discharged by 0.33 C to 2.7V.

An initial discharge capacity F1 was measured, and the charge and discharge cycle were repeated 100 times to measure a discharge capacity F2 in the 100th cycle.

A rapid charge capacity retention was calculated as follows.

Rapid charge capacity retention (%)=F2/F1×100(%)

### Experimental Example 2: Evaluation on Internal Resistance (DCIR)

The lithium secondary batteries of Examples and Comparative Examples were charged under a condition of 0.5 C CC/CV (4.2V 0.05 C CUT-OFF) at 25° C., and then discharged under a condition of 0.5 C CC to SOC 60%.

At the SOC 60%, C-rate was changed to 0.2 C, 0.5 C, 1.0 C, 1.5 C, 2.0 C and 2.5 C, while discharging and supplement charging for 10 seconds at each C-rate.

In the discharging and supplement charging, an end point of a voltage was set as an equation of a straight line, and a slope thereof was adopted as a DCIR.

### Experimental Example 3: Evaluation on Low Temperature Capacity

Lithium secondary batteries of Examples and Comparative Examples were subjected to 0.5 C CC/CV charging (4.2V, 0.05 C CUT-OFF) and 0.5 C CC discharging (2.7V CUT-OFF) at −10° C. three times, and a discharge capacity at the 3rd cycle was measured.

### Experimental Example 4: Evaluation on High Temperature Life-Span Properties

1) Evaluation on Capacity Retention (Ret.)

After charging the lithium secondary batteries of Examples and Comparative Examples at 0.5 C CC/CV (4.2V, 0.05 C cut-off), 0.5 C CC discharge (2.7V cut-off) was performed three times.

A discharge capacity at the 3rd cycle was defined as an initial capacity H1 of the lithium secondary battery.

The charged lithium secondary batteries of Examples and Comparative Examples were left at 60° C. for 12 weeks while being exposed to an air, left at room temperature for 30 minutes, and then 0.5 C CC discharged (2.7V cut-off) to measure a capacity H2.

The capacity retention after high-temperature storage was calculated according to the following equation.

Capacity Retention after High Temperature Storage (%)=H2/H1×100(%)

2) Evaluation on Cell Expansion (Cell Thickness Increase Ratio)

After charging the lithium secondary batteries of Examples and Comparative Examples at 25° C. at 0.5 C CC/CV (4.2V 0.05 C CUT-OFF), a battery thickness T1 was measured.

After the charged lithium secondary batteries of Examples and Comparative Examples were left at 60° C. in an air for 12 weeks, a battery thickness T2 was measured.

The thickness of the lithium secondary batteries was measured using a plate thickness measuring apparatus (Mitutoyo Co., Ltd., 543-490B).

A cell thickness increase ratio after high temperature storage was calculated as follows.

Cell thickness increase ratio (%)=(T2−T1)/T1×100(%)

TABLE 2

| | | | | | high |
|---|---|---|---|---|---|
| | | | low | high | temperature |
| | | rapid charge | temperature | temperature | storage cell |
| | | capacity | discharge | storage capacity | thickness |
| | DCIR | retention | capacity | retention | increase ratio |
| | (mΩ) | (%) | (mAh) | (%) | (%) |
| Example 1 | 32.6 | 93.5 | 1368 | 81.9 | 20.4 |
| Example 2 | 33.2 | 93.1 | 1341 | 84.2 | 13.3 |
| Example 3 | 32.4 | 91.6 | 1359 | 82.1 | 28.7 |
| Example 4 | 34.4 | 90.9 | 1335 | 86 | 5.8 |
| Example 5 | 31.5 | 92.9 | 1384 | 82.8 | 18.1 |
| Example 6 | 31.3 | 93.9 | 1354 | 76.7 | 5.6 |
| Comparative | 34.6 | 90.3 | 1316 | 81.7 | 71.3 |
| Example 1 | | | | | |
| Comparative | 35.9 | 89.3 | 1159 | 83.2 | 23.6 |
| Example 2 | | | | | |
| Comparative | 36.5 | 96.1 | 1029 | 77.6 | 55.4 |
| Example 3 | | | | | |
| Comparative | 35.2 | 94.8 | 929 | 22.6 | 14.2 |
| Example 4 | | | | | |

Referring to Table 2, the lithium secondary batteries of Examples provided low DCIRs and high-temperature storage cell thickness increase ratios, and improved low-temperature discharge capacities, rapid charge capacity retentions and high-temperature storage capacity retentions.

In the lithium secondary battery of Comparative Example 1, the same lithium metal oxide particles as those in Examples were used, but the mononitrile-based compound was not used. The lithium secondary battery of Comparative Example 1 provided entirely degraded results compared to those from the lithium secondary batteries of Examples.

The lithium secondary battery of Comparative Example 2 employed a multifunctional nitrile-based compound, and provided improved results in some evaluations compared to those from the lithium secondary battery of Comparative Example 1. However, in the lithium secondary battery of Comparative Example 2, the DCIR increased, and the rapid charge capacity retention and low-temperature discharge capacity were decreased.

The lithium secondary batteries of Comparative Examples 3 and 4 employed lithium metal oxide particles having composition different from those of Examples. Further, the lithium secondary battery of Comparative Example 3 did not employ the mononitrile-based compound, and the lithium secondary battery of Comparative Example 4 employed the mononitrile-based compound. Referring to Table 2, even in the lithium secondary battery of Comparative Example 4 using the mononitrile-based compound, the low-temperature discharge capacity and high-temperature storage capacity retention were explicitly lowered than those of the lithium secondary battery of Comparative Example 3.

From the evaluation results of Examples and Comparative Example 1, and the results of Comparative Examples 3 and 4, it is predicted that the mononitrile-based compound may provide a unique effect when used in combination with the lithium metal oxide particles having a specific composition range.

What is claimed is:

1. A lithium secondary battery, comprising:
a cathode comprising a cathode active material that includes lithium metal oxide particles;
an anode facing the cathode and comprising an anode active material; and
an electrolyte solution comprising a lithium salt and an organic solvent,
wherein the lithium metal oxide particles contain at least 80 mol % of nickel and less than 10 mol % of manganese among all elements excluding lithium and oxygen, and
the organic solvent comprises a mononitrile-based compound represented by Chemical Formula 1: 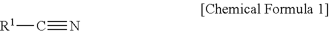
wherein, in Chemical Formula 1, R¹ represents a C₁-C₁₂ alkyl group.

2. The lithium secondary battery of claim 1, wherein the lithium metal oxide particles contain 88 mol % to 98 mol % of nickel among all elements excluding lithium and oxygen.

3. The lithium secondary battery of claim 1, wherein the lithium metal oxide particles contain 0.5 mol % to 6 mol % of manganese among all elements excluding lithium and oxygen.

4. The lithium secondary battery of claim 1, wherein a content of the mononitrile-based compound in the organic solvent is in a range from 1 vol % to 9 vol %.

5. The lithium secondary battery of claim 1, wherein, in Chemical Formula 1, R¹ is a C₂-C₄ linear alkyl group.

6. The lithium secondary battery of claim 1, wherein the organic solvent further comprises a cyclic carbonate-based solvent and a linear carbonate-based solvent.

7. The lithium secondary battery of claim 6, wherein a content of the linear carbonate-based solvent is greater than a content of the cyclic carbonate-based solvent in the organic solvent.

8. The lithium secondary battery of claim 6, wherein a volume ratio of the cyclic carbonate-based solvent to the mononitrile-based compound in the organic solvent is in a range from 5 to 25.

9. The lithium secondary battery of claim 6, wherein the linear carbonate-based solvent comprises a first dialkyl carbonate-based solvent having a C₂-C₄ alkyl group at both terminal ends thereof, and a second dialkyl carbonate-based solvent in which at least one terminal group is a methyl group.

10. The lithium secondary battery of claim 1, wherein the electrolyte solution further comprises an additive comprising at least one of a fluorine-containing cyclic carbonate-based compound represented by Chemical Formula 2 and a sultone-based compound represented by Chemical Formula 3: 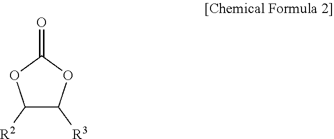
wherein, in Chemical Formula 2, R² and R³ are independently hydrogen, halogen, or a C₁-C₃ alkyl group, and at least one of R² and R³ is F, 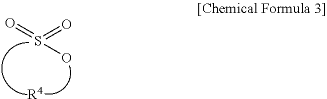
wherein, in Chemical Formula 3, R⁴ is a C₂-C₅ alkylene group or a C₃-C₅ alkenylene group.

11. The lithium secondary battery of claim 10, wherein a content of the additive is in a range from 0.1 wt % to 5 wt % based on a total weight of the electrolyte solution.

12. The lithium secondary battery of claim 10, wherein a content of the fluorine-containing cyclic carbonate-based compound is in a range from 0.1 wt % to 2 wt % based on a total weight of the electrolyte solution, and
a content of the sultone-based compound is in a range from 0.1 wt % to 1 wt % based on the total weight of the electrolyte solution.

13. The lithium secondary battery of claim 10, wherein the additive further comprises at least one of a fluorine-containing phosphate-based compound, a sulfate-based compound and a borate-based compound.

14. The lithium secondary battery of claim 1, wherein the electrolyte solution does not comprise a compound containing two or more nitrile groups.
